(19) United States
(12) Patent Application Publication
(10) Pub. No.: US 2004/0217700 A1
(43) Pub. Date: Nov. 4, 2004

(54) Full color organic electro-luminescence display panel with adjustable color purity and method of manufacturing the same

(76) Inventor: Shu-Wen Chang, Nantou City (TW)

Correspondence Address: BIRCH STEWART KOLASCH & BIRCH, PO BOX 747, FALLS CHURCH, VA, 22040-0747, US

(21) Appl. No.: 10/426,633

(22) Filed: May 1, 2003

(51) Int. Cl. H05B 33/00

(52) U.S. Cl. 313/506

(57) ABSTRACT

A full color organic electro-luminescence display panel with adjustable color purity and method of manufacturing the same employs an inverse depositing process to fabricate the panel. The method includes the steps: forming a barrier wall on a cathode; plating emitting layers by vaporization on the cathode; sputtering an anode on the emitting layers; plating by vaporization through a photo mask a half mirror interference layer that has interference effect and through the half mirror interference layer spacing from the cathode to form a microcavity therebetween light wave may resonate and interfere repeatedly in the microcavity to allow a selected light wave to generate a single wave of a super intensity for emitting thereby to achieve high saturation color light required on the full color panel.

### FIELD OF THE INVENTION

The present invention relates to a full color organic electro-luminescence display panel with adjustable color purity and a method of manufacturing the same, and particularly to a manufacturing technique that uses an inverse depositing process to fabricate a full color panel and employs a microcavity to increase light source utilization efficiency and the saturation of light color.

### BACKGROUND OF THE INVENTION

OLED (Organic Electro-Luminescence Display), according to the driving method, may be classified in Passive Matrix OLED (PMOLED) and Active Matrix OLED (AMOLED). They mainly are driven by electric current to enable an organic film to emit light. For the panel of a larger size, a greater current must be injected to maintain lighting uniformity of the panel. Consequently, element efficiency and service life are greatly reduced. Electric energy consumption also increases.

Ever since Kodak published the OLED technology in 1987, the OLED technology has a great advance. Light emitting efficiency of monochrome products has increased greatly. Nevertheless, the ultimate goal is still full color enabling. At present, the full color OLED technique is still under development. Full color OLED consists of repeating the pixels of three original color lights: red, blue and green (R, G, B). The finer the pixels, the greater the resolution becomes. At present, the prevailing full color techniques can be grouped into three categories: the first one is to add a color filter on the white color OLED panel; the second one is to let the red, blue and green colors to emit light independently; and the third one is a color transformation method that uses blue light as the light source, and employs a color transformation film to transform to red, blue and green light color.

The tricolor light emitting layer technique requires accurate control of the purity and efficiency of light emitting materials. The greatest bottleneck is the purity, efficiency and service life of the red light material. The technique of adding a color filter on the white light OLED panel to achieve full color enabling encounters a bottleneck of balancing the emitting wave length of the red, blue and green lights generated by the white light emitting material. Although this full color enabling technique has an advantage of directly using the LCD color filter, it has a poorer light penetration efficiency and degree comparing with independent emitting the red, blue and green light. On the other hand, the light color transformation method lacks red color material. This is its major bottleneck. Moreover, it must include an intermediate material for displaying the full color. As a result, light-emitting efficiency is lower.

In general, the brightness of an organic material varies inversely with the service life. Hence trying to achieve a balance between the two, in terms of the factors of service life, color purity and light emitting efficiency, the present development still does not reach the practical stage.

### SUMMARY OF THE INVENTION

Therefore the primary objective of the present invention is to solve the aforementioned problems and eliminate the drawbacks of cited prior art. The present invention provides a full color organic electro-luminescence display panel with adjustable color purity and a method of manufacturing the same. The invention employs resonant light wave of the light interference principle. On one side of an ITO (Indium Tin Oxide), an overlapping medium is laid to serve as an interference layer. It and the cathode form a resonant zone therebetween. The cathode serves as one end of the full reflection. Its principle is somewhat like the laser resonance. When the light wave resonates and interferes repeatedly in the resonant zone, a specific light wave is intensified and converged in the microcavity. A single wavelength of a super intensity can be obtained. Thereby light emitting efficiency can be improved and electric consumption is reduced. In addition, through the different intervals between the interference layer and cathode, lights of different colors may be obtained through resonance. Hence light color of the full color panel may be adjusted.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the manufacturing process of the present invention.

FIG. 2 is a cross-sectional diagram of the structure of a single pixel OLED of the present invention.

FIG. 3 is an illustrative structural diagram of the half mirror interference layer formed by vaporization plating of the present invention.

FIG. 4 is a chart showing a single wavelength of super intensity emitted after repetitive resonance and interference according to the present invention.

### DETAILED DESCRIPTION OF THE PREFERRED EMBODIMENT

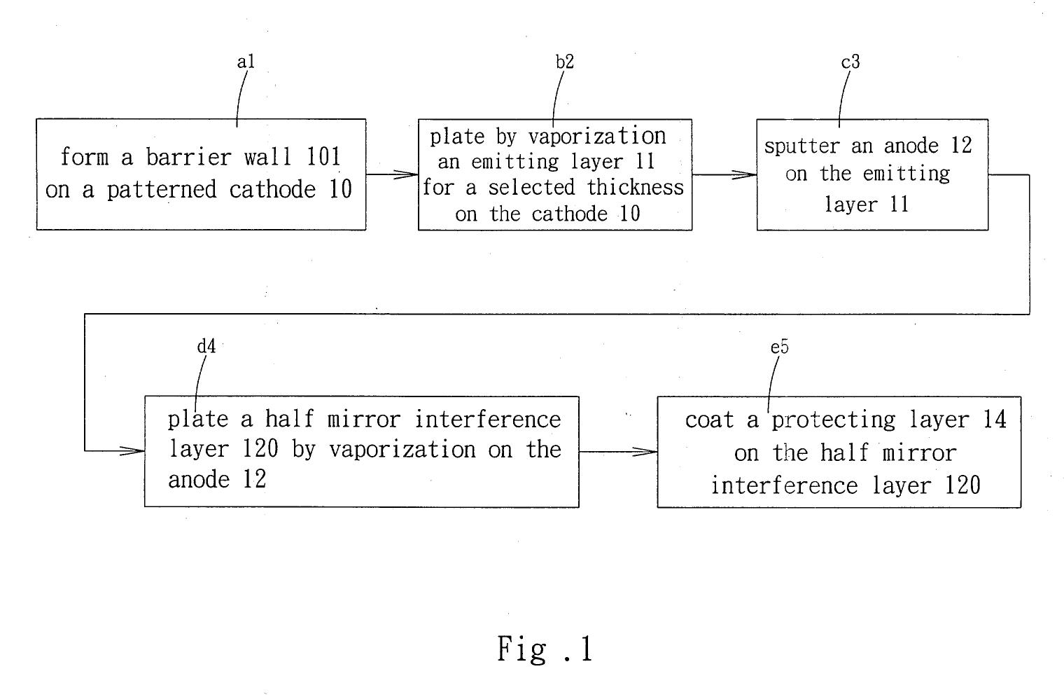

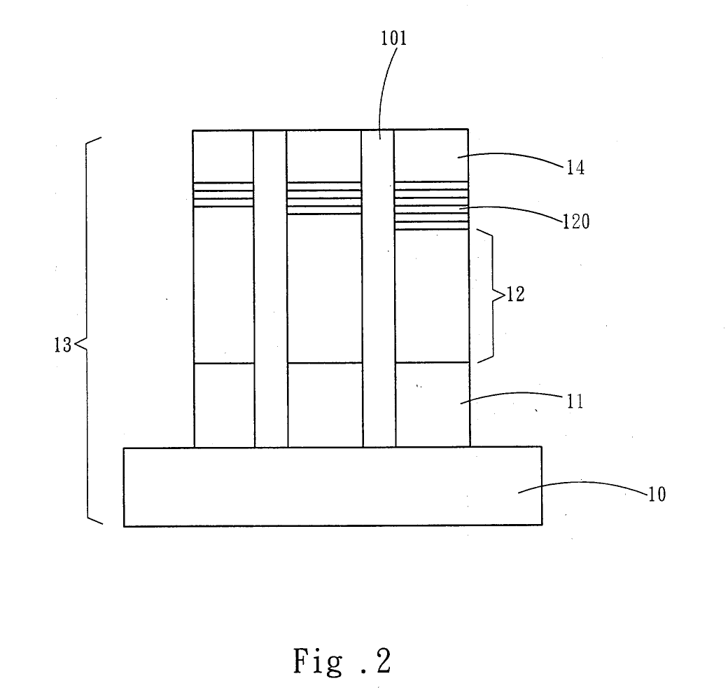

Please refer to FIGS. 1 and 2 for the block diagram of the manufacturing process and the cross-sectional diagram of the structure of a single pixel OLED of the present invention.

The full color organic electro-luminescence display panel with adjustable color purity according to the present invention mainly includes a cathode 10, an emitting layer 11 located on the cathode 10, an anode 12 located on the emitting layer 11, a half mirror interference layer 120 located on the anode 12, and a protecting layer 14 located on the half mirror interference layer 120.

The manufacturing process for making the full color organic electro-luminescence display panel with adjustable color purity of the invention mainly consists of the following steps:

step a1: forming a barrier wall 101 on the cathode 10. The cathode 10 may be made from a selected metal such as Mg, Ag, Ca, Al, Li or the like;

step b2: plating light emitting material of small molecules for generating red, blue and green light by vaporization plating through a photo mask to form an emitting layer 11 of the full color panel. The emitting layer 11 is controlled at a selected thickness during the vaporization plating;

step c3: sputtering an anode 12 on one side of the emitting layer 11. The anode 12 is an ITO conductive glass film and is formed at a selected thickness;

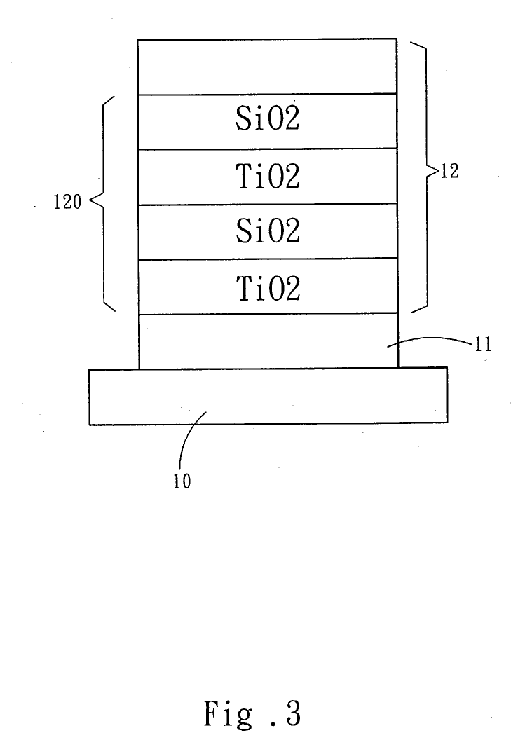

step 4d: forming a plurality of half mirror interference layers 120 by repetitive vaporization plating two types of material of different refraction indexes on the emitting side of the anode 12 as shown in FIG. 3. Overlapping layers are formed on one side of the ITO conductive transparent layer, wherein the half mirror interference layers 120 may have 21 layers, each layer has a thickness according to different wavelengths of the red, blue and green lights. The thickness of the vaporization plating is as follows:

| Red | (Å) | Green | (Å) | Blue | (Å) |
|---|---|---|---|---|---|
| TIO2 | 61.33 | SIO2 | 86.9 | SIO2 | 439.92 |
| SIO2 | 58.98 | TIO2 | 87 | TIO2 | 79.38 |
| TIO2 | 47.75 | SIO2 | 129 | SIO2 | 126.39 |
| SIO2 | 105.83 | TIO2 | 58.3 | TIO2 | 77.32 |
| TIO2 | 69.39 | SIO2 | 101 | SIO2 | 140.43 |
| SIO2 | 82.62 | TIO2 | 88 | TIO2 | 81.93 |
| TIO2 | 48.11 | SIO2 | 104 | SIO2 | 131.68 |
| SIO2 | 88.31 | TIO2 | 59.8 | TIO2 | 70.31 |
| TIO2 | 63.51 | SIO2 | 100 | SIO2 | 120.98 |
| SIO2 | 106.96 | TIO2 | 96.5 | TIO2 | 66.24 |
| TIO2 | 51.47 | SIO2 | 92.6 | SIO2 | 127.83 |
| SIO2 | 84.05 | TIO2 | 53.4 | TIO2 | 161.71 |
| TIO2 | 47.61 | SIO2 | 69.5 | SIO2 | 127.29 |
| SIO2 | 83.26 | TIO2 | 27.7 | TIO2 | 65.43 |
| TIO2 | 42.36 | SIO2 | 55.2 | SIO2 | 129 |
| SIO2 | 30.58 | TIO2 | 41.5 | TIO2 | 162.19 |
| TIO2 | 44.98 | SIO2 | 59.8 | SIO2 | 127.98 |
| SIO2 | 87.6 | TIO2 | 45.5 | TIO2 | 77.4 |
| TIO2 | 50.94 | SIO2 | 79.8 | SIO2 | 468.7 |
| SIO2 | 82.1 | TIO2 | 44.3 | TIO2 | 9.68 |
| TIO2 | 34.65 | SIO2 | 14.6 | SIO2 | 102.92 |
| | | TIO2 | 51 | | |
| Total | 1372.39 | Total | 1547 | Total | 2894.71 |
| thickness | | thickness | | thickness | |

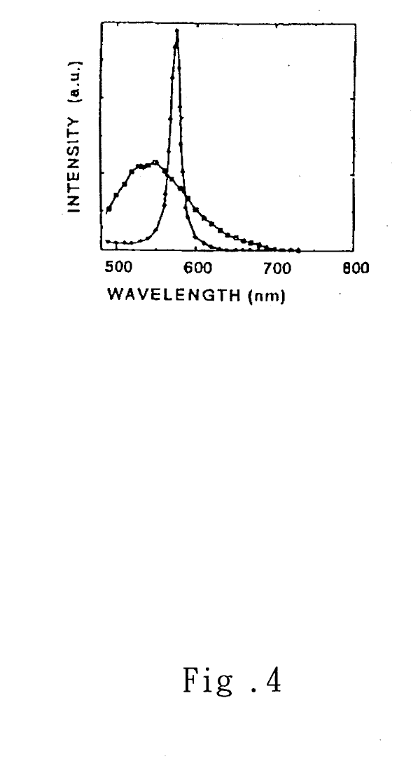

The half mirror interference layer 120 and the cathode 10 form a single microcavity 13 therebetween. When the light wave resonates and interferes repeatedly in the microcavity 13, a specific light wave is intensified and converged in the microcavity 13 and a single wave length of a super intensity may be obtained and emit as shown in FIG. 4. It is to be noted that for plating each microcavity 13 by vaporization, the thickness of vaporization plating must be made according to different wave lengths of the red, green and blue lights (the relationship of the length of the microcavity 13 and the wave length is: 2d =në, where d is the length of the microcavity, ë is wave length, and n is an integer) so that wave lengths of different color lights may generate resonance and interference (as shown in FIG. 2, the red light has a longer wave length than the green and blue lights, hence the thickness plated on the microcavity for the red light also is greater that the green and blue lights to achieve the full color panel effect).

The thickness of the microcavity 13 includes the cathode 10, emitting layer 11 and anode 12. Thus for plating the red light, green light and blue light on the microcavity 13 by vaporization, the layer structure and thickness (unit Å) is as follows:

Red light: ITO (anode) (1500 Å)/CuPc (an electron injection material, being copper cyanide dyestuff) (350 Å)/NPB (an electron transmission material, being aniline) (400 Å)/Alq (an electron transmission material, being Al-complex of quinine)+0.3% Rub (an orange color mixed emitting material)+0.8% DCJTB (a red color mixed emitting material) (400 Å)/Alq (an electron transmission material, being Al-complex quinine) (350 Å)/LiF (an electron injection layer, being Lithium Fluoride) (7 Å)/Al (cathode) (1500 Å).

Green light: ITO (anode) (1500 Å)/NPB (an electron transmission material, being aniline) (400 Å)/Alq (an electron transmission material, being Al-complex of quinine)+NPB (an electron transmission material, being aniline)+1.5% C545T (a green light mixed emitting material) (600 Å)/Alq (an electron transmission material, being Al-complex of quinine) (300 Å)/LiF (an electron injection layer, being Lithium Fluoride) (5 Å)/Al (1500)/Al (cathode) (1500 Å).

Blue light: ITO (anode) (1500 Å)/CuPc (an electron injection material, being copper cyanide dyestuff) (300 Å)/NPB (an electron transmission material, being aniline) (500 Å)/Ide-120 (a blue color mixed emitting material) +2.5% Ide 120 (a blue color mixed emitting material) (300 Å)/Alq (an electron transmission material, being Al-complex of quinine) (200 Å)/LiF (an electron injection layer, being Lithium Fluoride) (7 Å)/Al (cathode) (1500 Å).

step e5: coating a protecting layer 14 on the half mirror interference layer 120;

finally packaging and testing the element to complete the full color organic electro-luminescence display panel of the invention.

In view of the full color organic electro-luminescence display panel has a great potential, the invention employs an inverse depositing process to fabricate the display panel (first fabricating the cathode 10; next, plating the emitting layer 11 by vaporization; then sputtering the anode 12; plating a plurality of half mirror interference layers 120; coating the protecting layer 14; finally packaging and testing the element). One of the technical features of the invention is to fabricate the full color OLED panel that has microcavity resonant effect by vaporization plating through a photo mask. Thereby the interval between the half mirror interference layers 120 form a microcavity 13 which can adjust the wavelength of lights to allow a selected light to be intensified and converged in the microcavity to achieve a single wave length of a super intensity for emitting. The full color panel thus made has the required high saturation for the selected light color.

While the preferred embodiment of the invention has been set forth for the purpose of disclosure, modifications of the disclosed embodiment of the invention as well as other embodiments thereof may occur to those skilled in the art. Accordingly, the appended claims are tended to cover all embodiments, which do not depart from the spirit and scope of the invention.

What is claimed is:

1. A method for manufacturing full color organic electro-luminescence display panels by using an inverse depositing process, comprising steps of:
a1) forming a barrier wall on a cathode;
b2) plating by vaporization on one side of the cathode emitting layers of red, green and blue color for a selected thickness;
c3) sputtering an anode on one side of the emitting layers for a selected thickness;
d4) plating repeatedly a plurality of half mirror interference layers by vaporization on the emitting side of the anode using materials of two refraction indexes to form a single microcavity on the interval with the cathode, each microcavity being plated with a different thickness according to different wave lengths of the red, green and blue lights thereby to generate resonance and interference for the different color lights; and
e5) coating a protecting layer on the translucent layers.

2. The method of claim 1, wherein the emitting layers are plated by vaporization for a thickness according to the wave length of the red light including 0.3% Rub (an orange color mixed emitting material)+0.8% DCJTB (a red color mixed emitting material) (400 Å).

3. The method of claim 1, wherein the emitting layers are plated by vaporization for a thickness according to the wave length of the green light including 1.5% C545T (a green light mixed emitting material) (600 Å).

4. The method of claim 1, wherein the emitting layers are plated by vaporization for a thickness according to the wave length of the blue light including Ide-120 (a blue color mixed emitting material)+2.5% Ide 120 (a blue color mixed emitting material) (300 Å).

5. The method of claim 1, wherein the half mirror interference layers are plated respectively by vaporization according to different wave lengths of the red, green and blue lights at a thickness of 1372.30 Å, 1547 Å, and 2894.71Å.

6. A full color organic electro-luminescence display panel with adjustable color purity comprising:
a cathode;
an emitting layer located on the cathode;
an anode located on the emitting layer;
a half mirror interference layer located on the anode; and
a protecting layer located on the translucent layer;
wherein the half mirror interference layer located between the anode and the cathode forms a resonant zone, light wave being repeatedly resonated and interfered in the resonant zone to allow a selected light wave to be intensified and converged in a microcavity to obtain a single wave length of a super intensity.
